(19) United States
(12) Patent Application Publication
(10) Pub. No.: US 2001/0043243 A1
(43) Pub. Date: Nov. 22, 2001

(54) INK-JET HEAD, AND INK-JET-HEAD CARTRIDGE, AN INK-JET APPARATUS AND AN INK-JET RECORDING METHOD USED IN GRADATION RECORDING

(76) Inventors: MASAYOSHI TACHIHARA, TOKYO (JP); YASUYUKI TAMURA, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 08/783,367

(22) Filed: Jan. 16, 1997

(30) Foreign Application Priority Data
Jan. 16, 1996 (JP) 005067/1996

(51) Int. Cl. B41J 2/205

(52) U.S. Cl. 347/15; 347/47; 347/48; 347/63; 347/65

(57) ABSTRACT

An ink-jet head includes a plurality of ink channels for guiding ink to corresponding discharging ports, and discharging units, each including a discharging port, and a heating element, provided for the discharging port, for generating a bubble for discharging the ink by providing the ink within the corresponding ink channel with thermal energy. A plurality of discharging units having different amounts of ink discharge are provided at each of the ink channels. An ink-jet-head cartridge includes the above-described ink-jet head and an ink receptable for holding the ink to be supplied to the ink-jet head. An ink-jet apparatus includes the above-described ink-jet head and a recording-medium conveying unit for conveying a recording medium for receiving the discharged ink. In an ink-jet recording method, a head in which a plurality of discharging units, each including a heating element for generating heat for discharging ink, and a discharging port for discharging the ink, are provided at each ink channel is used, and recording is performed by discharging different amounts of ink from the discharging ports by selectively driving the plurality of discharging units.

### BACKGROUND OF THE INVENTION

1. Field of the Invention

This invention relates to an ink-jet head, an ink-jet head cartridge, an ink-jet apparatus and an ink-jet recording method for performing recording on a recording material by discharging an ink droplet using a pressure caused by the generation of a bubble.

2. Description of the Related Art

An ink-jet head performs recording on a recording material by generating a bubble by providing a heater with electric energy and discharging an ink droplet using a pressure caused by the generation of the bubble. Ink-jet heads are widely used because of their silent operation, the capability of high-density printing, the ease of color printing, and the like.

In order to stably drive an ink-jet head at a high speed with a high energy efficiency, and to perform high-density recording using an ink-jet head, various attempts have been made.

In order to perform gradation recording using an ink-jet head, Japanese Patent Laid-Open Application (Kokai) Nos. 55-132258 (1980) and 63-160853 (1988) disclose recording-liquid discharging heads in which a heater whose width or thickness has a gradient is disposed within an ink channel, and in which a plurality of heaters are disposed within an ink channel.

In order to efficiently discharge an ink droplet, for example, Japanese Patent Laid-Open Application (Kokai) No. 5-16365 (1993) discloses an approach in which a bubble is made to communicate with the air while the bubble grows. In this approach, since the distance between a heating resistor and a discharging port is short, the ratio of the work done by the bubble to the electric energy given to the heater is superior to such ratios of previous recording-liquid discharging heads. Furthermore, since almost all ink present between the heater and the discharging port is discharged, the volume of the discharged ink is stabilized.

The above-described conventional approaches, however, have the following problems to be solved.

First, the head for discharging ink by making the bubble to communicate with the air operates rather well when discharging a small ink droplet (equal to or less than 15×10⁻¹⁵ m³). However, when intending to discharge a relatively large ink droplet, it is necessary to increase the discharging port. As a result, the size of the discharging port greatly exceeds the distance between the heater and the discharging port, thereby providing a flat discharged droplet and causing instability in the direction of ink discharge. Furthermore, the capillary force while refilling ink decreases, thereby increasing the refilling time and causing incapability of high-speed recording.

On the other hand, in a conventional head in which discharging ports, each for discharging a very small droplet, are arranged at a high density, each of the discharging ports has an ink channel. Hence, each ink channel is narrow, thereby increasing the resistance of the channel and the refilling time.

In the heads in which a heater whose width or thickness has a gradient is disposed within an ink channel communicating with a discharging port and in which a plurality of heaters are disposed within an ink channel in order to perform gradation recording, since there is a correlation between the volume of a discharged ink droplet and the discharging speed, the quality of the recorded image is degraded.

That is, if it is arranged to discharge large droplets at appropriate discharging speeds, the discharging speeds of small droplets decrease, thereby causing instability in the direction of ink discharge and in the recorded image. On the other hand, if it is arranged to discharge small droplets at appropriate discharing speeds, the discharging speeds of large droplets greatly increase, thereby causing splashing when the droplets reach the recording material, and degrading the quality of the recorded image.

### SUMMARY OF THE INVENTION

It is an object of the present invention to provide an ink-jet head, an ink-jet-head cartridge, an ink-jet apparatus and an ink-jet recording method which can discharge ink at an appropriate speed whether the volume of the ink is small or large and which can refill the ink at a high speed.

It is another object of the present invention to provide a recording-liquid discharging head or the like which can particularly perform gradation recording excellently.

According to one aspect, the present invention which achieves these objectives relates to an ink-jet head for discharging ink from discharging ports by the generation of bubbles, comprising a plurality of ink channels for guiding the ink to the corresponding discharging ports, and discharging units, each comprising a discharging port, and a heating element, provided for the discharging port, for generating a bubble for discharging the ink by providing the ink within the corresponding ink channel with thermal energy. A plurality of discharging units having different amounts of ink discharge are provided at each of the ink channels.

According to another aspect, the present invention which achieves these objectives relates to an ink-jet-head cartridge comprising the above-described ink-jet head and an ink receptable for holding the ink to be supplied to the ink-jet head.

According to still another aspect, the present invention which achieves these objectives relates to an ink-jet apparatus comprising the above-described ink-jet head, and recording-medium conveying means for conveying a recording medium for receiving the discharged ink.

According to still another aspect, the present invention which achieves these objectives relates to an ink-jet recording method for performing recording by discharging different amounts of ink from discharging ports, comprising the steps of using a head in which a plurality of discharging units, each including a heating element for generating heat for discharging the ink, and a discharging port for discharging the ink, are provided at each ink channel, and performing recording by discharging different amounts of ink from the discharging ports by selectively driving the plurality of discharging units.

According to the above-described configurations and method, it is possible to excellently discharge ink droplets having different sizes, and to achieve gradation recording of a high picture quality. Furthermore, since discharging ports can be arranged at a high density, recording of higher precision can be achieved.

### BRIEF DESCRIPTION OF THE DRAWINGS

FIGS. 1(a) and 1(b) are schematic diagrams illustrating the configuration of an ink-jet head according to a first embodiment of the present invention: FIG. 1(a) is a plan view; and FIG. 1(b) is a cross-sectional view taken along line A-A′ shown in FIG. 1(a);

FIG. 2 is a diagram illustrating the pattern of interconnections for heaters H and h shown in FIG. 1(b);

FIG. 3 is a graph illustrating the relationship between the meniscus amplitude of a discharging port t shown in FIGS. 1(a) and 1(b) when driving the heater H, and the center distance between the heaters H and h;

FIG. 4 is a diagram illustrating a driving circuit for a pair of heaters shown in FIG. 1(b);

FIG. 5 is a schematic diagram illustrating the configuration of an ink-jet head according to a second embodiment of the present invention;

FIG. 6 is a diagram illustrating the pattern of interconnections for heaters H and h corresponding to discharging ports t and t′ shown in FIG. 5, respectively;

FIG. 7 is a schematic diagram illustrating the configuration of an ink-jet head according to a third embodiment of the present invention;

FIG. 8 is a schematic diagram illustrating the arrangement of discharging ports in a fourth embodiment of the present invention;

FIG. 9 is a perspective view illustrating the configuration of an ink-jet-head cartridge according to the present invention; and

FIG. 10 is a perspective view illustrating the configuration of an ink-jet apparatus according to the present invention.

### DETAILED DESCRIPTION OF THE PREFERRED EMBODIMENTS

Preferred embodiments of the present invention will now be described in detail with reference to the drawings.

First Embodiment

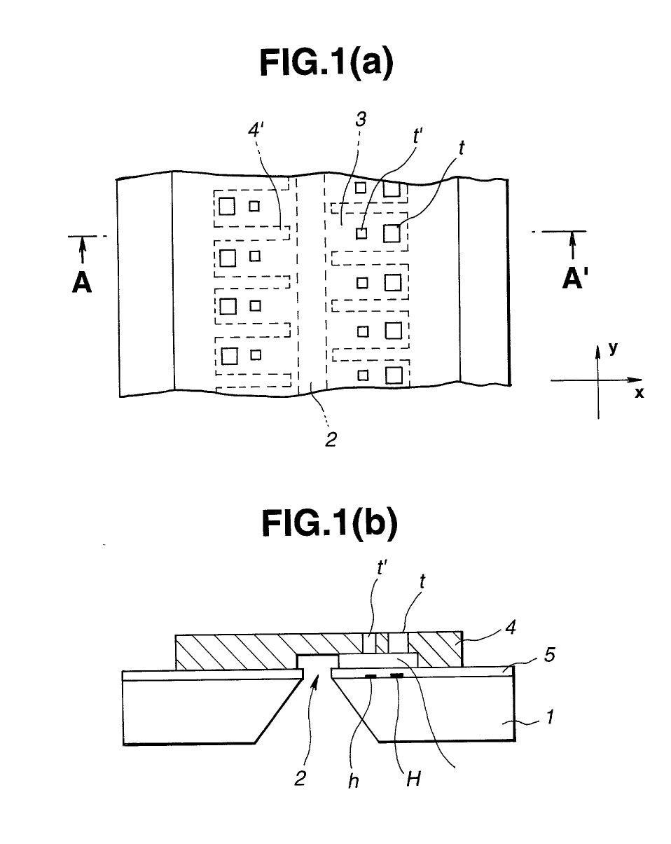

FIGS. 1(a) and 1(b) are schematic diagrams illustrating the configuration of an ink-jet head according to a first embodiment of the present invention: FIG. 1(a) is a plan view; and FIG. 1(b) is a cross-sectional view taken along line A-A′ shown in FIG. 1(a).

In this head, an ink supply port 2 is formed in a silicon substrate 1 using anisotropic etching. Ink passes from the ink supply port 2 having a width of 57.1 μm through each of ink channels 3, and ink droplets are discharged from discharging ports t and t′ which constitute a discharging unit. Heating elements (heaters) H and h, which constitute the discharging unit together with the discharging ports t and t′, are disposed substantially immediately below the discharging ports t and t′, respectively, which are provided at each of the ink channels 3. A channel provision member (nozzle member) 4 includes partitions 4′ for providing the ink channels 3 and the discharging ports t and t′, and is formed by a well-known production method comprising an exposure technique, etching and the like. Reference numeral 5 represents a protective film.

Respective pairs of heaters H and h are arranged in the y direction at a pitch of 84.7 μm in a staggered manner across the supply port 2. The head performs recording by performing scanning in the x direction. The pixel pitch of the head is 84.7 μm both in the x and y directions. Recording of 8,000 pixels per second is performed at the maximum speed with the pair of t and t′ (or H and h). Accordingly, the maximum scanning speed of the head is (84.7/2 μm)×8,000/sec=338.8 mm/sec.

The partition 4′ (for separating adjacent ink channels) hydraulically separates adjacent pairs, and has a width of 12.7 μm. The distal end of the partition 4′ is situated at a position of 10 μm from the end of the supply port 2. The sheet resistance of the heater is 80Ω, and the resistance of the interconnection is about 0.2Ω. The driving signal (pulse) has a rectangular waveform, and the driving voltage is 14.5 V. The pulse widths are 4.0 μsec and 2.5 μsec for the heaters H and h, respectively. The ink used is obtained by dissolving 4% of C.I. Food Black 2 in an aqueous solution of DEG with a ratio of 80% of DEG and 20% of water.

The size of the discharging port t is 25 μm×25 μm, the size of the discharging port t′ is 18 μm×18 μm, the size of the heater H is 32 μm×32 μm, and the size of the heater h is 24 μm×24 μm. The thickness of the nozzle material 4 is 20 μm, and the thickness of the portion of the discharging ports is 9 μm.

When individually driving the heaters H and h, the volumes of ink discharged from the discharging ports t and t′ are 11×10⁻¹⁵ m³ and 5×10⁻¹⁵ m³, respectively. When simultaneously driving the heaters H and h, the volumes of ink discharged from the discharging ports t and t′ are also 11×10⁻¹⁵ m³ and 5×10⁻¹⁵ m³, respectively, and ink can be discharged from the discharging ports t and t′ for the same pixel. Accordingly, recording with one of four-step amounts of ink, i.e, 0 m³, 5×10⁻¹⁵ m³, 11×10⁻¹⁵ m³ and 16×10⁻¹⁵ m³, can be selected in accordance with image data. When simultaneously driving the heaters H and h, the discharging speeds from t and t′ are 19 m/s and 18 m/s, respectively. The refilling times are 95 μsec and 70 μsec for t and t′, respectively.

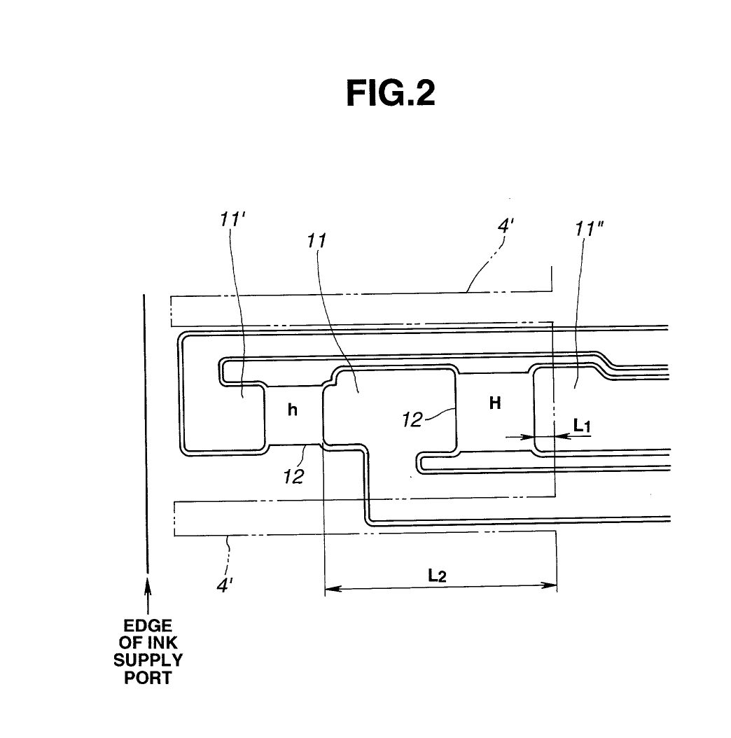

FIG. 2 is a diagram illustrating the pattern of interconnections for the heaters H and h. In FIG. 2, reference numeral 11 represents an A1 interconnection layer of a common electrode, reference numeral 11′ represents an A1 interconnection layer of an individual electrode for the heater h, and reference numeral 11″ represents an A1 interconnection layer of an individual electrode for the heater H. Reference numeral 12 represents a heater layer (HfB2 layer). As for the relative position between the partition and the heaters, L₁=3 μm, and L₂=92 μm. Since the size of the heater H is 32 μm×32 μm as described above, the shortest distance between the heaters H and h is 92 μm−3 μm−32 μm=57 μm. This value is arranged to be sufficiently larger than the distance of 20 μm between the heater and the distal end of the discharging port, so that ink is not discharged from another discharging port when one of the heaters H and h is driven.

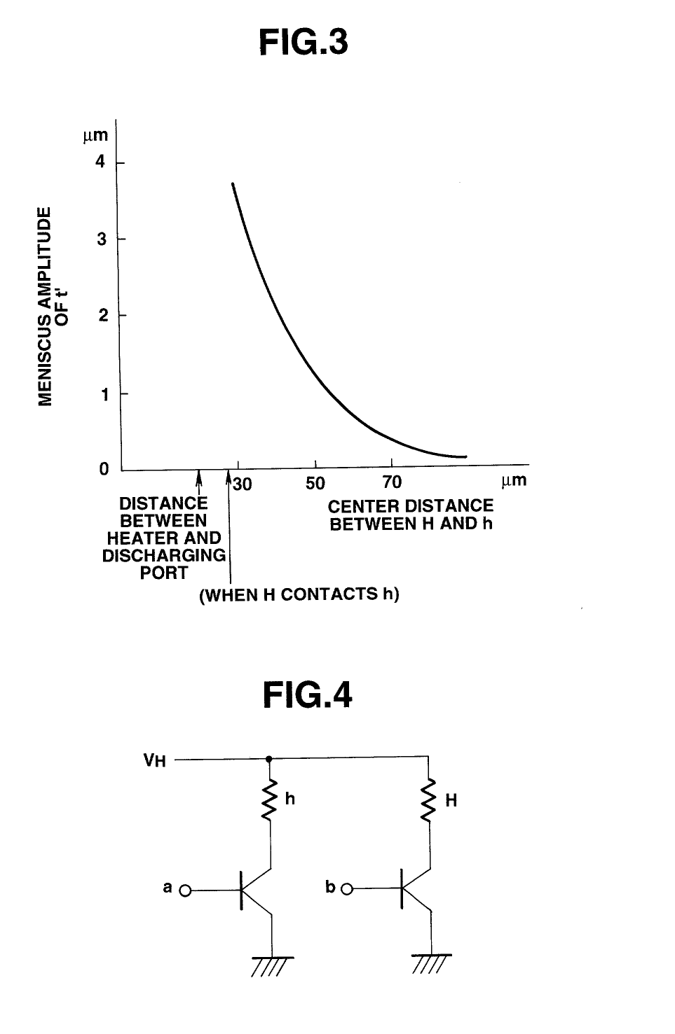

FIG. 3 is a graph illustrating the relationship between the meniscus amplitude of the discharging port t′ (immediately above the heater h) when driving the heater H, and the center distance between the heaters H and h. FIG. 3 indicates that even if the heater h approaches the heater H in a state of substantially contacting the heater H, an ink droplet is not discharged from the discharging port t′. Such a property is obtained in the first embodiment because the height of the channel is very low (9 μm) and the distance between the heater and the discharging port is also short (20 μm).

The center distance between the heaters H and h is 92 μm+(24 μm/2)−3 μm−(32 μm/2)−85 μm, which value substantially equals the distance between two pixels. Actually, however, no problem arises if the center distance is arranged to be about an integer multiple of pixels±20 μm. The distance between heaters facing across the supply port 2, for example, the distance in the x direction between the heater H at the right column and the heater h at the left column is 254.1 μm in FIG. 1, which equals the distance between six pixels. Accordingly, in the right column, the heater H performs recording of a pixel which precedes the heater h by two pixels, and the right column performs recording of a pixel which precedes the left column by six pixels.

When individually discharging ink from each discharging port in the above-described manner, in order to prevent ink from being discharged from another discharging port, it is desirable that the distance OH between the heater and the discharging port is equal to or less than 30 μm, and HC/OH>1 (HC: the center distance between the heaters).

FIG. 4 is a driving circuit for a pair of heaters. In FIG. 4, VH represents the power supply for driving the head, “a” represents a driving-signal input unit for the heater h, and “b” represents a driving-signal input unit for the heater H.

This head has 128 pairs of heaters at one side of the supply port, and therefore has 256 pairs of heaters in total. Respective 16 pairs of heaters in 16 blocks are sequentially driven from above (the +y direction). The time difference between adjacent blocks is 7 μsec. Hence, when, for example, recording a vertical line, the line shifts at every block and becomes oblique as a whole. In order to prevent such a phenomenon, scanning is performed in a state in which the head is inclined by tan⁻¹(2.3716/677.6) with respect to the y axis.

In the first embodiment, by using four (black, yellow, magenta and cyan) heads having the above-described configuration, four-value color recording with a pitch of 42.35 um (600 dpi (dots per inch) can be realized.

As a modification of the first embodiment, it is, of course, possible to maintain the linearity of recording of a vertical line by shifting the distance between the heater and the end of the supply port by 2.37 μm at every driving block, instead of inclining the head in the above-described manner.

In the first embodiment, the heaters H and h, and the orifices t and t′ have different sizes. However, the present invention is not limited to such a case. For example, only one of the pairs may have different sizes.

In the head of the first embodiment, a bubble generated on the heater protrudes from the discharging port during its growth to communicate with the air.

Second Embodiment

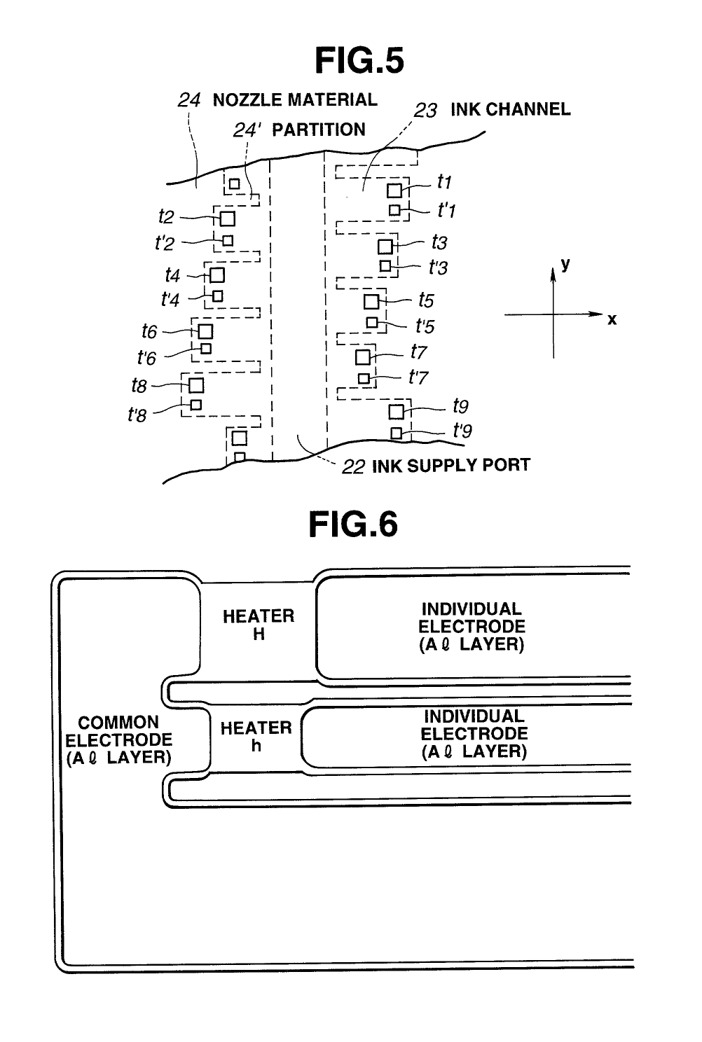

FIG. 5 is a schematic diagram illustrating the configuration of an ink-jet head according to a second embodiment of the present invention. FIG. 6 is a diagram illustrating the pattern of interconnections for heaters H and h corresponding to discharging ports t and t′, respectively, shown in FIG. 5.

The second embodiment differs from the first embodiment in that large and small heaters for a pixel are arranged in the y direction instead of being arranged in the x direction. The head of the second embodiment has recording densities of 1,200 pixels/25.4 mm in the x direction and 600 pixels/25.4 mm in the y direction. 64 pairs of heaters are provided at the right and left sides in total. The sizes of the discharging ports t and t′ are 16 μm×16 μm and 13 μm×13 μm, respectively. The sizes of heaters H and h corresponding to the discharging ports t and t′ are 20 μm (width)×24 μm (length) and 15 μm (width)×20 μm (length), respectively. The center distance between the heaters is 22 μm. The thickness of the nozzle member is 17 μm, and the thickness of the orifice portion is 8 μm. The volumes of ink discharge when individually driving the heaters H and h are 5×10⁻¹⁵ m³ and 3×10⁻¹⁵ m³, respectively, and the volume of ink discharge when simultaneously driving the heaters H and h is about 8×10⁻¹⁵ m³. The discharging speeds at that time from the discharging ports t and t′ are 18 m/s and 16 m/s, respectively, and the refilling times for the discharging ports t and t′ are 60 μsec and 45 μsec, respectively. When driving one of the heaters H and h, the meniscus of another orifice oscillates, but a droplet is not discharged. FIG. 6 is a diagram illustrating the pattern of interconnections for the heaters. The same driving circuit as that used in the first embodiment is used.

In FIG. 5, pairs of discharging ports (t₁, t′₁), (t₂, t′₂), . . . are arranged with a period of eight pairs, and the difference in the x coordinate between adjacent pairs is 5.30 μm. Driving is performed in the sequence of (t₈ₙ₊₁, t′₈ₙ₊₁), (t₈ₙ₊₂, t′₈ₙ₊₂), . . . , (t₈ₙ₊₇, t′₈ₙ₊₇) (n=0, 1, 2, 3, 4, 5, 6 and 7). The time difference in driving for adjacent blocks is 12.5 μsec.

Using this head, four-value recording could be excellently performed with 600×1,200 pixels/25.4² mm².

Third Embodiment

In the first and second embodiments, an ink channel for a pixel and an ink channel for an adjacent pixel are separated from each other using a partition. A third embodiment of the present invention has a feature in that, even when simultaneously driving heaters for a plurality of pixels, the heaters are disposed within an ink channel without being separated by a partition.

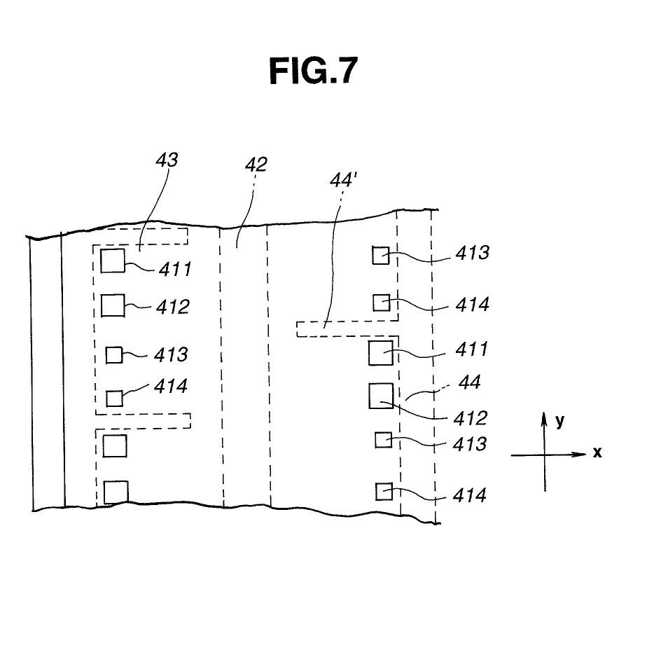

FIG. 7 is a diagram illustrating the arrangement of discharging ports of an ink-jet head according to the third embodiment. In FIG. 7, discharging ports 411-414 are disposed immediately above corresponding (four) heaters (not shown) which are simultaneously driven. The four discharging ports are disposed within an ink channel 43. The size of the discharging ports 411 and 412 is 22 μm×22 μm. The size of corresponding heaters is 26 μm×32 μm, and the amount of ink discharge is 8×10⁻¹⁵ m³ (8 p1). On the other hand, the size of discharging ports 413 and 414 is 17 μm×17 μm, the size of corresponding heaters is 24 μm×26 μm, and the amount of ink discharge is 4×10⁻¹⁵ m³ (4 pl). When discharging ports at the left columm are large discharging ports (411, 412), discharging ports present in the x-axis direction at the right column are small discharging ports (413, 414). That is, discharging ports are arranged in the sequence of large and small or small and large in the x-axis direction. Accordingly, when performing recording by moving the head in the x-axis direction, ink droplets having large and small amounts of ink discharge can be superimposed on a pixel at a single scanning operation. As a result, this head can achieve recording having four gradation steps, i.e., 0 pl, 4 pl, 8 pl and 12 pl. The discharging ports are arranged at a pitch of 35.4 μm. Since discharging ports at one column facing discharging ports at another column across an ink supply port 42 are arranged in a staggered manner, a pixel density of 35.4 μm/2 is obtained.

An adjacent group of heaters separated from a group of heaters by a partition discharges ink at a timing shifted by 8 μsec from the concerned group of heaters.

The thickness of the nozzle material is 20 μm, and the thickness of the portion of the discharging ports is 8 μm. Hence, the height of the channel is 12 μm. When one heater is driven, ink is not discharged from adjacent discharging ports separated by 35.4 μm within the same block, except that the meniscus slightly oscillates. Accordingly, even if four heaters surrounded by a partition are simultaneously driven, an interaction influencing a discharging operation is not produced. However, the provision of a plurality of heaters driven at different timings within the same block is not preferable, because, for example, while the meniscus of a discharging port is being refilled, a high-pressure bubble is generated from another heater to discharge a very small droplet.

In the third embodiment, the discharging speed is 15 μm/s, and the refilling time is 120 μsec.

Fourth Embodiment

In a fourth embodiment of the present invention, as in the foregoing embodiments, a plurality of discharging ports capable of discharging different amounts of ink which are simultaneously driven are provided within an ink channel.

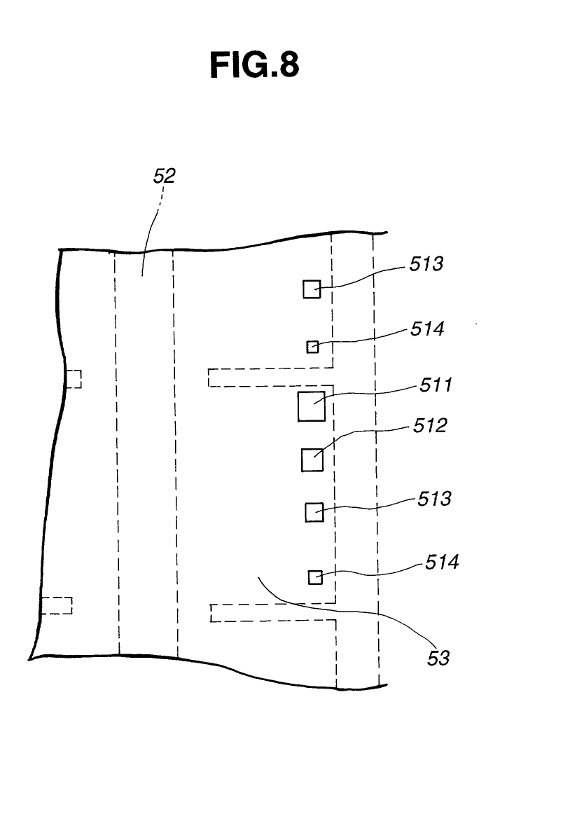

FIG. 8 is a schematic plan view illustrating the arrangement of discharging ports of an ink-jet head of the fourth embodiment. As in the third embodiment, discharging ports 511-514 are arranged at positions facing corresponding heaters.

In the fourth embodiment, four discharging ports for discharging different amounts of ink are provided in an ink channel 53 branching from an ink supply port 52 for supplying the head with ink. The sizes of the discharging ports 511, 512, 513 and 514 are 28 μm×28 μm, 22 μm×22 μm, 17 μm×17 μm and 13 μm×13 μm, respectively. The sizes of corresponding heaters are 34 μm×34 μm, 26 μm×34 μm, 26 μm×26 μm and 24 μm×24 μm, respectively. These pairs are arranged at a pitch of 42.2 μm. The amounts of ink discharge of these discharging units are 17.6×10⁻¹⁵ m³ (17.6 pl), 8.8×10¹⁵ m³ (8.8 pl), 4.4×10⁻¹⁵ m³ (4.4 pl) and 2.2×10⁻¹⁵ m³ (2.2 pl). The structure of other components of the head are the same as in the third embodiment.

When performing recording by performing scanning using such a head, if it is arranged to record one pixel by a plurality of scanning operations, recording having 16 gradation steps comprising integer multiples of 2.2 pl and having a maximum value of 33 pl can be achieved. When performing recording by two scanning operations, recording may be performed using the discharging ports 513 and 514 at a second scanning operation for a region where recording has been performed using the discharging ports 511 and 512 at a first scanning operation.

Other Embodiments

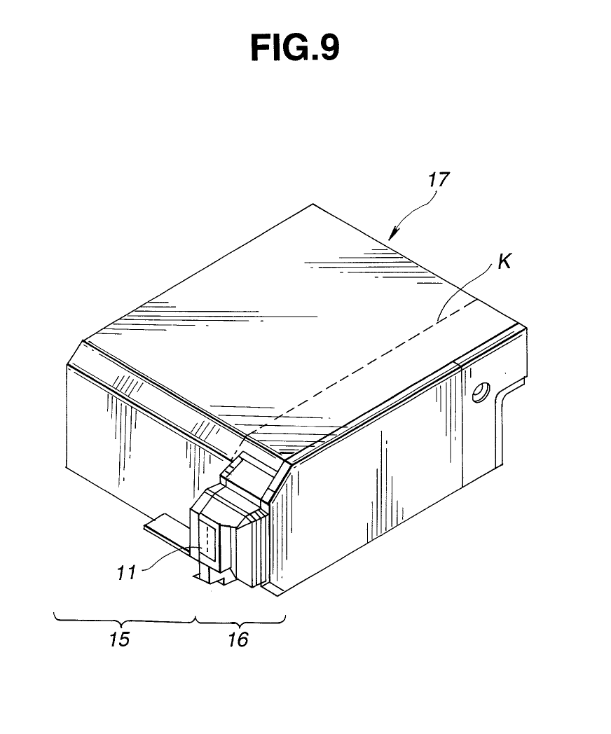

FIG. 9 illustrates an ink-jet-head cartridge 17 in which an ink-jet head 16 having discharging ports 11 of the invention and an ink receptacle 15 holding ink to be supplied to the ink-jet head are separably connected at the position of a boundary line K. The ink-jet-head cartridge 17 includes an electric contact (not shown) for receiving an electric signal from a carriage of an apparatus when the ink-jet-head cartridge 17 is mounted in the carriage. The head is driven by the electric signal.

The ink receptacle 15 constituting the ink-jet-head cartridge 17 incorporates a fibrous or porous ink absorbing member in order to hold ink. The ink is held by this ink absorbing member.

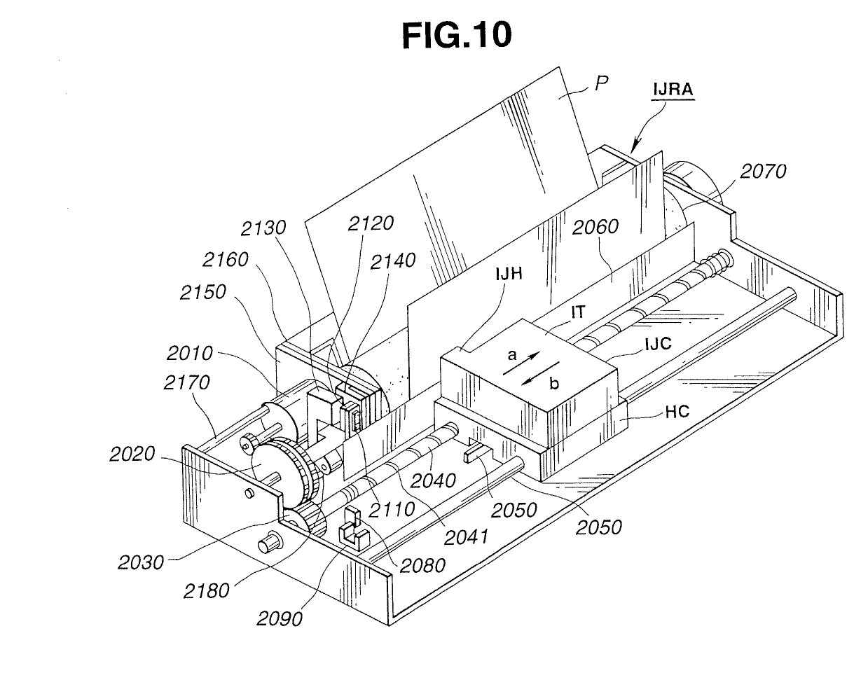

FIG. 10 illustrates an external appearance of an inkjet recording apparatus in which the ink-jet head having the above-described configuration is mounted. This ink-jet recording apparatus IJRA includes a lead screw 2040 rotating linked with the forward or reverse rotation of a driving motor 2010 via driving-force transmission gears 2020 and 2030. A carriage HC where an ink-jet cartridge IJC in which the ink-jet head and an ink tank is integrated is mounted is supported on a carriage shaft 2050 and the lead screw 2040. The carriage HC includes a pin (not shown) engaging with a sprial groove 2041 of the lead screw 2040, and is reciprocated in the directions of arrows “a” and “b” in accordance with the rotation of the lead screw 2040. A sheet pressing plate 2060 presses paper P against a platen roller 2070, constituting conveying means for conveying a recording medium, over the moving range of the carriage HC. Members 2080 and 2090 constitute a photocoupler which operates as home-position detection means for confirming the presence of a lever 2100 provided on the carriage HC in this region and performing, for example, switching of the direction of revolution of the motor 2010. A member 2110 for capping the entire surface of the ink-jet head is supported on a supporting member 2120. Suction means 2130 for sucking the inside of the cap performs recovery by suction of the ink-jet head via an opening in the cap. A cleaning blade 2140 for cleaning the end surface of the ink-jet head is provided on a member 2150 so as to be movable in the forward and backward directions. The member 2150 is supported on a supporting plate 2160 of the main body of the apparatus. The structure of the cleaning blade 2140 is not limited to the above-described one, but any well-known cleaning blade may, of course, be used. A lever 2170 for recovering suction is moved in accordance with the movement of a cam 2180 engaging with the carriage HC. The driving force from the driving motor 2010 is thereby transmitted by well-known transmission means, such as clutch switching or the like.

The apparatus is configured such that each of the capping, cleaning, and recovery by suction can be performed at a corresponding position by the operation of the lead screw 2040 when the carriage HC is in the region of the home position. However, any other approach may be adopted provided that a desired operation is performed at a known timing.

The ink-jet recording apparatus of the present invention also includes driving-signal supply means for supplying. the head with a signal for driving the heating elements of the ink-jet head of the present invention.

According to the present invention having the above-described configurations, ink can be discharged at an appropriate speed whether the volume of the ink droplet is large or small. It is thereby possible to achieve high-precision gradation recording. Furthermore, since a plurality of discharging units for discharging different amounts of ink are disposed within an ink channel, the density of the arrangement of discharging ports can be very high. According to the structures of the above-described embodiments, it is also possible to provide an appropriate discharging speed of ink and to shorten the time to refill the ink.

The individual components shown in outline in the drawings are all well known in the ink-jet head, ink-jet-head cartridge, ink-jet apparatus and ink-jet recording method arts and their specific construction and operation are not critical to the operation or the best mode for carrying out the invention.

While the present invention has been described with respect to what are presently considered to be the preferred embodiments, it is to be understood that the invention is not limited to the disclosed embodiments. To the contrary, the present invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An ink-jet head for discharging ink from discharging ports by the generation of bubbles, said head comprising:
a plurality of ink channels for guiding the ink to the corresponding discharging ports; and
discharging units, each comprising a discharging port, and a heating element, provided for the discharging port, for generating a bubble for discharging the ink by providing the ink within the corresponding ink channel with thermal energy,
wherein a plurality of discharging units having different amounts of ink discharge are provided at each of the ink channels.

2. An ink-jet head according to claim 1, wherein the discharging port and the heating element constituting said discharging unit face each other.

3. An ink-jet head according to claim 1, wherein said plurality of discharging units differ in the size of the discharging port or in the size of the heating element.

4. An ink-jet head according to claim 1, wherein said plurality of discharging units differ both in the size of the discharging port and in the size of the heating element.

5. An ink-jet-head cartridge for discharging ink from discharging ports by the generation of bubbles, said cartridge comprising:
an ink-jet head comprising a plurality of ink channels for guiding the ink to the corresponding discharging ports, and discharging units, each comprising a discharging port, and a heating element, provided for the discharging port, for generating a bubble for discharging the ink by providing the ink within the corresponding ink channel with thermal energy, a plurality of discharging units having different amounts of ink discharge being provided at each of the ink channels; and
an ink receptable for holding the ink to be supplied to said ink-jet head.

6. An ink-jet-head cartridge according to claim 5, wherein the discharging port and the heating element constituting said discharging unit face each other.

7. An ink-jet-head cartridge according to claim 5, wherein said plurality of discharging units differ in the size of the discharging port or in the size of the heating element.

8. An ink-jet-head cartridge according to claim 5, wherein said plurality of discharging units differ both in the size of the discharging port and in the size of the heating element.

9. An ink-jet apparatus for discharging ink from discharging ports by the generation of bubbles, said apparatus comprising:
an ink-jet head comprising a plurality of ink channels for guiding the ink to the corresponding discharging ports, and discharging units, each comprising a discharging port, and a heating element, provided for the discharging port, for generating a bubble for discharging the ink by providing the ink within the corresponding ink channel with thermal energy, a plurality of discharging units having different amounts of ink discharge being provided at each of the ink channels; and
recording-medium conveying means for conveying a recording medium for receiving the discharged ink.

10. An ink-jet apparatus according to claim 9, wherein the discharging port and the heating element constituting said discharging unit face each other.

11. An ink-jet apparatus according to claim 9, wherein said plurality of discharging units differ in the size of the discharging port or in the size of the heating element.

12. An ink-jet apparatus according to claim 9, wherein said plurality of discharging units differ both in the size of the discharging port and in the size of the heating element.

13. An ink-jet recording method for performing recording by discharging different amounts of ink from discharging ports, said method comprising the steps of:
using a head in which a plurality of discharging units, each including a heating element for generating heat for discharging the ink, and a discharging port for discharging the ink, are provided at each ink channel; and
performing recording by discharging different amounts of ink from the discharging ports by selectively driving the plurality of discharging units.

14. An ink-jet recording method according to claim 13, wherein a pixel is formed by superimposing different amounts of ink.

15. An ink-jet recording method according to claim 13, wherein a bubble is generated within the ink by the generation of the heat, and the ink is discharged by making the bubble to communicate with the air.
